(19) United States
(12) Patent Application Publication
(10) Pub. No.: US 2017/0130482 A1
(43) Pub. Date: May 11, 2017

(54) ACCESSORY FOR SECURITY LOCKING OF A LOCK

(71) Applicant: OVIKU OY, Vantaa (FI)

(72) Inventor: Tomi EK, Vantaa (FI)

(73) Assignee: OVIKU OY, Vantaa (FI)

(21) Appl. No.: 15/319,609

(22) PCT Filed: Jun. 18, 2014
(86) PCT No.: PCT/FI2014/050489

§ 371 Date: Dec. 16, 2016

(51) Int. Cl. E05B 27/00; E05C 1/10; E05B 1/00; E05B 13/00; E05B 63/14; E05B 63/22

(52) U.S. Cl. CPC E05B 27/0057; E05B 63/146; E05B 63/22; E05B 1/003; E05B 13/001; E05C 1/10

(57) ABSTRACT

An accessory for the security locking of a lock. A dead-boltable external door lock is capable of being locked with the accessory from inside in such a way that the lock cannot be opened with a key or a picklock. The lock includes a lock body, a twist knob, a key cylinder, and a shaped spindle present between the twist knob or a handle and the lock body and in engagement with a lock mechanism. An accessory is between the twist knob or a handle and the lock body and the accessory includes a body and a safety latch propped on the body, which is movable from a security locking release position to a security locking position in which the shaped spindle is locked in a non-rotatable manner against turning effected with a key or a twist knob or a handle.

The invention relates to an accessory for the security locking of a lock, said accessory enabling the locking of a lock from inside in such a way that the lock cannot be opened with a key or a picklock, the lock including a lock body, a twist knob, a key cylinder, and a shaped spindle present between the twist knob and the lock body and in engagement with a lock mechanism.

Since the accessory according to the invention is applicable to a wide range of lock types, the invention relates also to an accessory for the security locking of a lock, said accessory enabling the locking of a dead-boltable door lock from inside in such a way that the lock cannot be opened with a key or a picklock, the lock including a lock body, handles on both sides of the door, a twist knob, a key cylinder, and a shaped spindle present between the handles and in engagement with a lock mechanism.

Publication FI 20105696 discloses a lock accessory, by means of which a dead-bolted lock can be operated with a wireless electric control for opening the same with a handle from outside the door. This accessory features an electromechanical switch, which precludes opening of the lock from outside unless the lock receives a correct control signal. Other than that, the lock operates conventionally and can be opened with a key or a picklock. A lock accessory with similar features is known from publication US 2011265527. Just the mechanical implementation is different.

A problem with prior known locks of the foregoing type is the possibility of unauthorized opening of the lock with illegitimate copy keys or master keys or a picklock.

It is an objective of the invention to provide an accessory, whereby the above problem can be solved and which enables the locking of a dead-boltable exterior door lock from inside in such a way that the lock cannot be opened with a key or a picklock.

This objective is attained in the invention on the basis of characterizing features as presented in claim 1 or 2. Preferred embodiments of the invention are presented in the dependent claims.

One exemplary embodiment of the invention will now be described more closely with reference to the accompanying drawings, in which

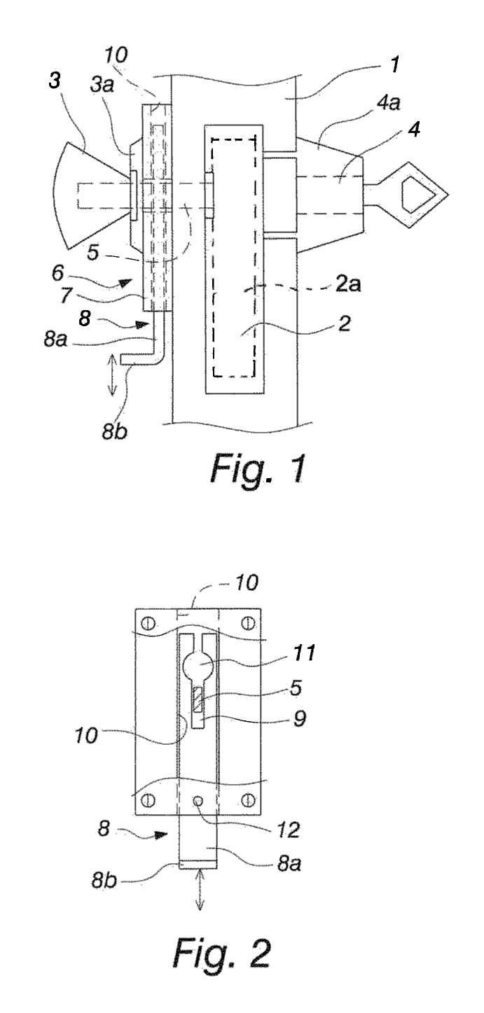

FIG. 1 shows a lock equipped with an accessory of the invention in a view along the plane of a door,

FIG. 2 shows an accessory of the invention in a view perpendicular to the direction of the door plane

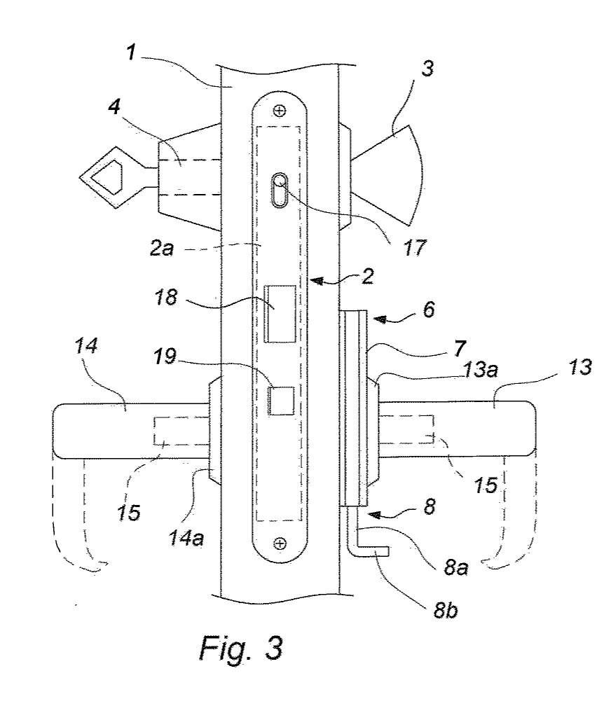

FIG. 3 shows another type of lock equipped with an accessory of the invention in a view along the plane of a door,

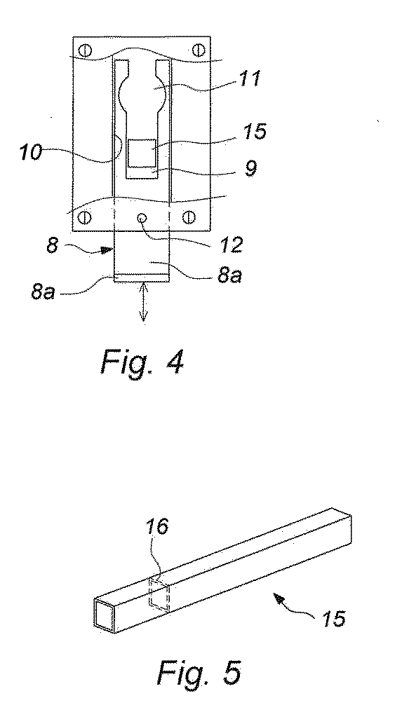

FIG. 4 shows the lock accessory of FIG. 3 in a view perpendicular to the direction of the door plane in a partially cut-away view,

FIG. 5 shows a quadratic spindle for the lock of FIG. 3,

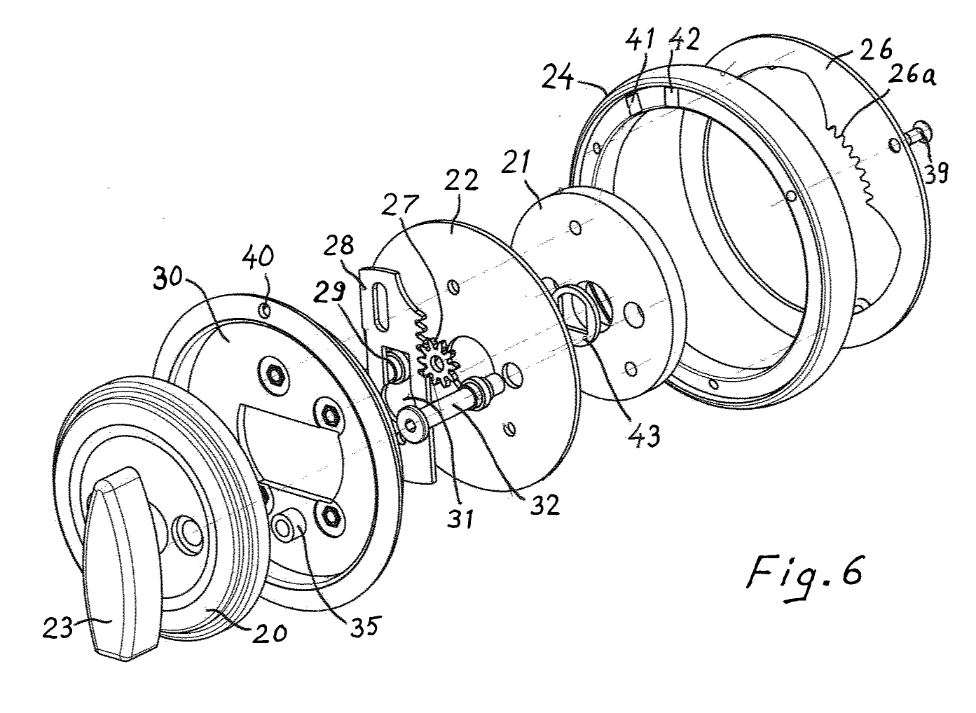

FIG. 6 shows an accessory according to a second embodiment of the invention in an exploded view,

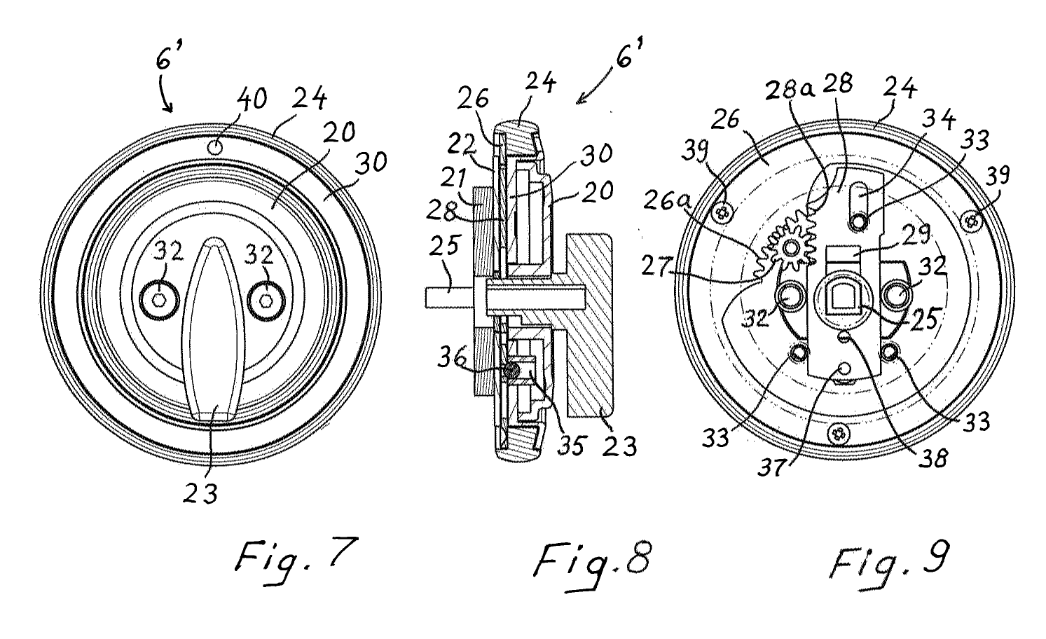

FIGS. 7-9 show the accessory of FIG. 6 in views from the front, in section, and from behind,

FIGS. 10 and 11 show essential components for the accessory of FIGS. 6-9 in a condition enabling the opening of a lock at various rotational positions of the twist knob, and

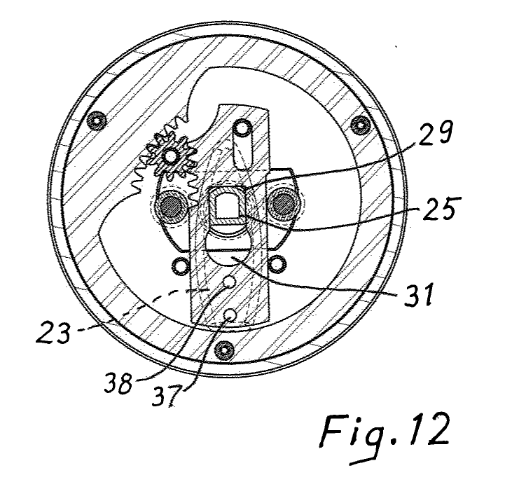

FIG. 12 shows essential components for the accessory of FIGS. 6-11 in a condition precluding the opening of a lock.

Reference is first made to the embodiment shown in FIGS. 1 and 2.

A lock body 2, embedded in a door 1, houses a conventional lock mechanism 2a which translates the rotational movements of a key and a twist knob 3 into the movement of a latch. The twist knob 3 and a key cylinder 4 are on opposite sides of the door and the lock body. A shaped spindle 5 exists between the twist knob 3 and the lock body 2. The shaped spindle 5 is in engagement with the lock mechanism 2a and extends into the interior of the twist knob 3. In this embodiment, the shaped spindle 5 is a flat type spindle, a so-called torsion bar, which is typically 7 mm in height and 1.5-2 mm in thickness. In some lock bodies, the shaped spindle is threaded. In the process of implementing the invention, a possible threaded shaped spindle has been replaced by a smooth shaped spindle.

An accessory of the invention is fitted between the twist knob 3 and the lock body 2. In the present case, an accessory 6 has its body 7 between a surface of the door 1 and the twist knob 3. The accessory has its body 7 securely fitted with a safety latch 8, which is movable from a security locking release position to a security locking position in which the shaped spindle 5 is locked in a non-rotatable manner.

In the described exemplary embodiment, the safety latch 8 has a slot 9 whose width matches essentially a thickness of the shaped spindle, such that the slot 9 receives the shaped spindle 5 with a sliding fit in the security locking position of the safety latch 8. As the safety latch 8 is pulled downward in the figure, the shaped spindle 5 slides from the slot 9 into a hole 11 of the safety latch, wherein the shaped spindle 5 is capable of free rotation. Accordingly, a pulled-down position of the safety latch 8 is the security locking release position. In case of a dead-boltable lock mechanism, the invention can only be used with the lock mechanism in a dead-bolted position, i.e. in a so-called night position. In a daytime position, the safety latch cannot be shifted to the security locking position as this is prevented by the design and position of the shaped spindle.

In the described embodiment, the safety latch 8 is displaceable linearly in the direction of the slot 9, and the body 7 includes a space 10 in the direction of displacement, in which the safety latch 8 is able to travel

In the described embodiment, the safety latch 8 is L-shaped, the L having its vertical leg 8a co-directional with the door surface and its horizontal leg 8b extending away from the door surface. Thus, the horizontal leg 8b constitutes a handle for the safety latch. The handle and the safety latch can be locked in the security locking position e.g. with a powerful magnet, one opposite side of which is included in the door or in the body 7 and the other opposite side in the safety latch 8. A locking for the safety latch 8 can also be established by means of a locking pin 12, which passes into holes present in the safety latch and in the door or in the body 7 and coinciding with each other when the safety latch has been raised to the security locking position.

With the safety latch 8 emerging from the body below the body 7, the accessory does not inadvertently enter the security locking position.

The accessory can be secured in place with long fastening screws for a ferrule 3a of the twist knob, which engage with a protective enclosure 4a of the key cylinder 4. Thus, the fastening screws must be made longer than the ordinary ones. Other changes to the basic lock are not needed (except, possibly, said replacement of a threaded shaped spindle with a smooth one). The accessory can be constructed from plastic sheets or metal plates, e.g. with three of those placed on top of each other, whereby the space 10 can be readily established by leaving a corresponding space in the middlemost plate.

What has been presented above is just one possible embodiment and there are other structural implementations for the invention. For example the safety latch 8 can be a pivoting lever, which is pivotably mounted with bearings on the body 7 and by turning of which a slot, similar to the slot 9, can be shifted to a position locking or releasing the shaped spindle 5. In this case, as well, attention must be paid to masses on various sides of the lever turning bearing so as to avoid an accidental activation of the security locking as a result of gravity. Movements of the safety latch 8 can also be influenced by a return spring and a retainer design.

Reference is next made to the embodiment of FIGS. 3-5. It differs from its predecessor mainly in terms of a lock type, whereby the location and the shaped spindle are also different.

A lock body 2, embedded in a door 1, houses a conventional lock mechanism 2a, which translates the rotational movement of a shaped spindle 15, produced by pressing down a handle 13 or 14, into the movement of a latch 18. In certain lock types, however, this lock opening function is not possible in a dead-bolted position prior to the turning motion of a key or a twist knob 3. If, in the dead-bolted position (a stud 17 up), the key or the twist knob is not turned, the handle 13, 14 makes an idle motion and the lock does not open. FIG. 3 shows in dash-dot lines a pressed-down position of the handles 13 and 14.

The twist knob 3 and a key cylinder 4 are on opposite sides of the door and the lock body. The square shaped spindle 15 is present between the handles 13, 14 and inserted in square-shaped reception recesses of the handles, whereby both handles 13, 14 turn jointly as one is turned. The shaped spindle 15 is in engagement with the lock mechanism 2a. The shaped spindle 15 may also be rectangular in shape, but in current lock models it has a square-shaped cross-section.

An accessory of the invention is fitted between the internal door handle 13 and the lock body 2. In the present case, an accessory 6 has its body 7 between a surface of the door 1 and the handle 13. The accessory has its body 7 securely fitted with a safety latch 8, which is movable from a security locking release position to a security locking position in which the shaped spindle 15 is locked in a non-rotatable manner.

In the described exemplary embodiment, the safety latch 8 has a slot 9 whose width matches essentially a thickness between sides of the shaped spindle 15, such that the slot 9 receives the shaped spindle 15 with a sliding fit in a security locking position of the safety latch 8. Hence, the shaped spindle extends through the slot 9. As the safety latch 8 is pulled downward in the figure, the shaped spindle 15 slides from the slot 9 into a hole 11 of the safety latch, wherein the shaped spindle 15 is capable of free rotation. Accordingly, a pulled-down position of the safety latch 8 is the security locking release position. When using the invention, the lock mechanism 2a must be in a dead-bolted position, i.e. in a so-called night position (the stud 17 up). Likewise in a daytime position, the safety latch can be in the security locking position, but it is not advisable so as to avoid burdening the accessory unnecessarily. In order to prevent a forced breaking of the accessory by pressing or turning the external handle 14, the shaped spindle 15, in a preferred embodiment of the invention, is provided with a weakening 16 which is located outside the reception recess of the external handle 14 between the lock body 2 and the handle 14. The weakening 16 is dimensioned in such a way that the shaped spindle fractures at the weakening before its corners cut into the material of the safety latch 8 and break the security locking device. In the presented embodiment, the working and design of the safety latch 8 match those of the above-described embodiment of FIGS. 1 and 2.

The accessory can be secured in place with long fastening screws for a ferrule 13a of the handle 13, which engage with a ferrule 14a of the handle 14. Thus, the fastening screws must be made longer than the ordinary ones. Other changes to the basic lock are not needed. The accessory can have its body 7 constructed from plastic sheets or metal plates, e.g. with three of those placed on top of each other, whereby a space 10 can be readily established by leaving a corresponding space in the middlemost plate.

Next described will be the embodiment of FIGS. 6-12, which is suitable e.g. for the lock of FIG. 1, replacing the accessory 6 presented therein. In terms of its form, a shaped spindle 25 corresponds to what is a common shape in American locks, in which one side of the square shaped spindle is rounded.

An accessory 6′ includes a front plate 20 and a back plate 21, the latter guiding the accessory to its position in a door recess matching the back plate 21. A safety latch 28 is located between a bottom plate 22 and a front plate mounting support 30, which is also the location of a gear ring 26 with its toothed arc 26a. A finger wheel 24 is fixed to the gear ring 26 with screws 39.

The shaped spindle 25, attached to a twist knob 23, extends through the accessory 6′ and protrudes from the accessory sufficiently far for an engagement with the lock mechanism (e.g. the lock mechanism 2a in FIG. 1). Inside the accessory 6′, the shaped spindle 25 is made thicker with a sleeve of the twist knob, which constitutes a part of the shaped spindle 25. The shaped spindle 25 extends through a slot 29, which is present in a safety latch 28 and has at its bottom end an enlargement hole 31 dimensioned for allowing rotation of the shaped spindle 25 therein. Within the confines of the slot 29, the shaped spindle is not capable of rotating. The safety latch 28 can be moved downwards in such a way that the shaped spindle ends up in the slot 29 only when the shaped spindle has its curved side upwards. Movements of the twist knob and the shaped spindle are restricted in the lock action such that the shaped spindle 25 can only have its curved side facing sideways (the lock open) or upwards (the lock closed).

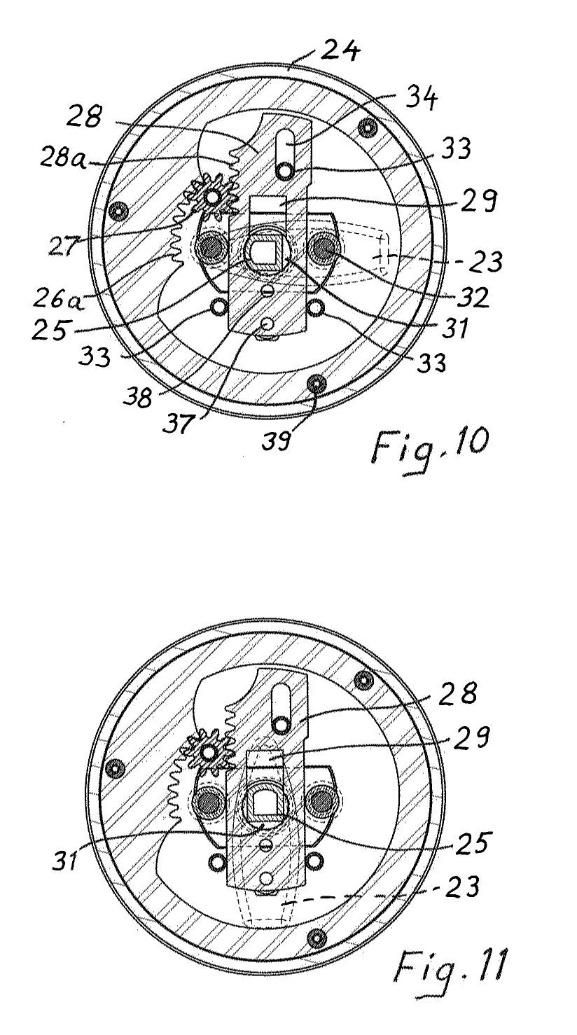

The accessory 6′ is assembled for a compact package with screws connecting the front plate mounting support 30 and the back plate 21 to each other. Around these screws can be fitted guide sleeves 33 for the safety latch (FIG. 9). The mounting support 30 can be formed at appropriate points with bulges, which bear against the bottom plate 30 and maintain the mounting support 22 and the bottom plate 30 at a sufficient distance from each other to facilitate a movement of the safety latch 28. A bearing 43 (FIG. 6) aligns the shaped spindle 25 with a center hole of the bottom plate 22.

Between a gear rack 28a of the safety latch and the toothed arc 26a is a pinion 27, which translates a rotary motion of the finger wheel 24 and the gear ring 26 into a vertical motion of the safety latch 28. The guide sleeves 33 and a guide slot 34 of the safety latch prevent a lateral movement of the safety latch. A bushing 35 of the mounting support receives a retainer ball 36, which is pressed against the safety latch 28 by a spring in the bushing 35. The safety latch has two retainer holes 37 and 38 spaced from each other by a distance matching its range of vertical motion. When the retainer ball comes across the retainer hole (either 37 or 38), the safety latch shall remain at a respective position, i.e. at the upward opening position (hole 37) or the downward security locking position (hole 38). The safety latch can be operated between these positions by turning on the finger wheel 24 whenever the shaped spindle 25 is in a locking position of the lock (the curved side upwards). If, at this time, the safety latch has been shifted to a bottom position shown in FIG. 12, it impedes turning of the shaped spindle 25 and opening of the lock with a key or a picklock. Visible through an aperture 40 in a rim of the mounting support is an indication 41 or 42, which is present on an internal periphery of the finger wheel 24 and whose color (e.g. red or green) indicates a user in the room whether the security locking is on. These indications can also be generated with LED lights provided that the accessory is equipped with a battery or a power supply. If the accessory is provided with a battery or a power supply, the safety latch maneuvering can be obtained with electrical drive such as a servo, a solenoid, or a motor. In this case, the safety latch maneuvering can be controlled wirelessly with a remote controller.

The accessory 6′ is secured to the door and to the lock body with fastening bolts 32 passing therethrough, the internal ends thereof, which engage with the front plate 20, being rotatable with a tool. The external ends are smooth and cannot be grappled with a tool. These bolts can be provided with enlargement sleeves on each side of the safety latch, establishing an external support for the slot 29 of the safety latch should the shaped spindle 25 therein be subjected to forcible twisting.

The accessory according to the invention can be applied particularly to locks used in exterior doors or patio doors. Hence, the possibility of mechanically manipulating the safety latch from outside the door must be completely precluded. In other words, the mechanical operating elements of the safety latch can only be mechanically manipulated from inside the door. From outside the door, however, it is possible to allow the manipulation of an electrically operated safety latch controlled with a security code.

1. An accessory for the security locking of a lock, said accessory enabling the locking of a lock from inside in such a way that the lock cannot be opened with a key or a picklock, the lock including a lock body (2), a twist knob (3, 23), a key cylinder (4), and a shaped spindle (5, 25) present between the twist knob (3, 23) and the lock body (2) and in engagement with a lock mechanism (2a), characterized in that an accessory (6, 6′) is between the twist knob (3, 23) and the lock body (2) and the accessory includes a body (7, 22, 30) and a safety latch (8, 28) propped on the body and movable from a security locking release position to a security locking position in which the shaped spindle (5, 25) is locked in a non-rotatable manner against turning effected with a key or a twist knob.

2. An accessory for the security locking of a lock, said accessory enabling the locking of a dead-boltable door lock from inside in such a way that the lock cannot be opened with a key or a picklock from outside the door, the lock including a lock body (2), handles (13, 14) on both sides of the door, a twist knob (3), a key cylinder (4), and a shaped spindle (15) present between the handles (13, 14) and in engagement with a lock mechanism (2a), characterized in that an accessory (6) is between the internal door handle (13) and the lock body (2) and the accessory includes a body (7) and a safety latch (8) propped on the body, which is movable from a security locking release position to a security locking position in which the shaped spindle (15) is locked in a non rotatable manner against turning effected with a key or a handle.

3. An accessory according to claim 1, characterized in that the safety latch (8, 28) has a slot (9, 29) whose width matches a thickness of the shaped spindle (5, 15, 25), such that the slot (9, 29) receives the shaped spindle (5, 15, 25) with a sliding fit in the security locking position of the safety latch (8, 28) and releases the shaped spindle (5, 15, 25) for a free rotation in the security locking release position.

4. An accessory according to claim 3, characterized in that the safety latch (8, 28) is displaceable linearly in the direction of the slot (9, 29), and that the accessory has its body (7, 22, 30) provided with a space (10) in the direction of displacement, in which the safety latch (8, 28) is able to travel.

5. An accessory according to claim 1, characterized in that the body (7, 22, 30) exists between a surface of the door (1) and the twist knob (3, 23).

6. An accessory according to claim 1, characterized in that the safety latch (8) is L-shaped, the L having its vertical leg (8a) co-directional with a surface of the door (1) and its horizontal leg (8b) extending away from the door surface, whereby the horizontal leg (8b) constitutes a handle for the safety latch.

7. An accessory according to claim 1, characterized in that the safety latch (8) emerges from the body (7) below the body.

8. An accessory according to claim 1, characterized by locking elements (12, 36, 38), whereby the safety latch (8, 28) is capable of being locked in the security locking position.

9. An accessory according to claim 1 or, characterized in that the safety latch (28) is provided with a gear rack (28a), which is in engagement with a pinion (27) meshed with a finger wheel's (24) toothed are (26a), the safety latch (28) being displaceable by rotating the finger wheel (24).

10. An accessory according to claim 1, characterized in that the possibility of mechanically operating the safety latch (8, 28) is restricted to the inside of a door.

11. An accessory according to claim 2, characterized in that the safety latch (8, 28) has a slot (9, 29) whose width matches a thickness of the shaped spindle (5, 15, 25), such that the slot (9, 29) receives the shaped spindle (5, 15, 25) with a sliding fit in the security locking position of the safety latch (8, 28) and releases the shaped spindle (5, 15, 25) for a free rotation in the security locking release position.

12. An accessory according to claim 2, characterized in that the safety latch (8) is L-shaped, the L having its vertical leg (8a) co-directional with a surface of the door (1) and its horizontal leg (8b) extending away from the door surface, whereby the horizontal leg (8b) constitutes a handle for the safety latch.

13. An accessory according to claim 2, characterized in that the safety latch (8) emerges from the body (7) below the body.

14. An accessory according to claim 2, characterized by locking elements (12, 36, 38) whereby the safety latch (8, 28) is capable of being locked in the security locking position.

15. An accessory according to claim 2, characterized in that the possibility of mechanically operating the safety latch (8, 28) is restricted to the inside of a door.
